(19) United States
(12) Patent Application Publication
(10) Pub. No.: US 2008/0198403 A1
(43) Pub. Date: Aug. 21, 2008

(54) IMAGE FORMING APPARATUS AND CONTROL METHOD THEREOF

(75) Inventor: Takaya Ooishi, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/017,044

(22) Filed: Jan. 20, 2008

(30) Foreign Application Priority Data
Feb. 20, 2007 (JP) 2007-039826

(51) Int. Cl. G06F 15/16

(52) U.S. Cl. 358/1.15

(57) ABSTRACT

An image forming apparatus includes a device information acquisition unit configured to acquire information about at least one remote device registered as a target device with which the at least one device cooperates, from at least one device, a display control unit configured to display at least one candidate remote device to be registered as a target device with which the image forming apparatus cooperates based on the information acquired by the device information acquisition unit, a selection unit configured to select the at least one candidate device to be registered as a target device with which the image forming apparatus cooperates, and a registration unit configured to register any selected at least one candidate remote device.

### BACKGROUND OF THE INVENTION

1. Field of the Invention

The present invention relates to an image forming apparatus capable of performing cooperative processing with a device connected through a network, and a control method of the image forming apparatus.

2. Description of the Related Art

In resent years, copying machines connected to a network cooperate with each other to perform copying functions such as remote copy, and cascade copy (tandem copy). The remote copy refers to a function of printing data that is read by a copying machine by using another copying machine connected to the network. The cascade copy (tandem copy) refers to a function of simultaneously printing data that is read by a copying machine by using both the copying machine and another copying machine connected to the network. In the cascade copy, any number of other copying machines may be used for the simultaneous printing. The cascade copy is used to intensively perform mass copying in a short time.

To perform the remote copy and the cascade copy, it is required that a cooperation destination (i.e., a target copying machine) is set in advance to the copying machine which reads the data. To set a copying machine that cooperates in printing, there is a method for searching for a device connected to the network according to a function to be realized, and selecting the searched device. For example, in the case where a user instructs copying processing using a staple function, if a copying machine that has read data of an original does not have the staple function, a copying machine that has the staple function is designated as the print destination among the copying machines connected to the network.

For example, in Japanese Patent Application Laid-Open No. 2002-94722, operation modes for forming an image in a plurality of multifunction peripherals (MFP) connected to a network are displayed on a display unit of a MFP. A user of the MFP selects a desired operation mode from the displayed operation modes and sets the selected operation mode. According to the set operation mode, functional information of the MFPs on the network is acquired. Then, MFPs on the network that can perform image formation according to the operation mode are searched based on the acquired functional information. Every time a desired operation mode is set, the search in the network is performed. Based on the search result, the display contents are updated and displayed in the display unit of the MFP. Accordingly, while the functional status of the MFPs on the network is checked, the setting of the distributed processing can be quickly and readily performed.

However, in the above-described conventional technique, in an operation mode, if a MFP implementing the operation mode is registered as a remote device by many MFPs, jobs may be centered on the registered MFP. Generally, users perform the remote copy or the cascade copy to increase efficiency in copy processing. However, if the MFP registered as the remote copy destination or the cascade copy destination is also registered by many other MFPs as the remote device, jobs are concentrated on the MFP and then, the efficiency in copy processing is actually decreased.

### SUMMARY OF THE INVENTION

The present invention is directed to a method of registering a remote device which can prevent efficiency reduction in remote copy or cascade copy processing.

According to an aspect of the present invention, an image forming apparatus includes a device information acquisition unit configured to acquire information about at least one remote device registered as a target device with which the at least one device cooperates, from at least one device a display control unit configured to display at least one candidate remote device to be registered as a target device with which the image forming apparatus cooperates based on the information acquired by the device information acquisition unit, a selection unit configured to select the at least one candidate device to be registered device as a target device with which the image forming apparatus cooperates, and a registration unit configured to register any selected at least one candidate remote device.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a view illustrating a printing system according to an exemplary embodiment of the present invention.

FIG. 2 is a block diagram illustrating a functional configuration of a MFP according to the exemplary embodiment of the present invention.

FIG. 3 is a view illustrating an example of functional information of each device which is managed by a functional information processing, unit according to the exemplary embodiment of the present invention.

FIGS. 4A and 4B are views illustrating a remote destination registration candidate list which is managed by a remote device management unit according to the exemplary embodiment of the present invention.

FIG. 5 is a flowchart illustrating an example of a flow of searching for a MFP which is to be registered as a slave of a MFP-X in a case where the MFP-X is newly connected to a local area network (LAN).

### DETAILED DESCRIPTION OF THE EMBODIMENTS

Various exemplary embodiments, features, and aspects of the invention will be described in detail below with reference to the drawings.

FIG. 1 is a view illustrating a printing (image formation) system according to an exemplary embodiment of the present invention.

MFPs 102, 103, and 104 are multifunctional devices that have an image input function and an image output function respectively, and each MFP can perform processing such as reading of an image (scanner unit), and printing (printer). The MFPs 102, 103, and 104 transmit and receive data to and from other devices via a local area network (LAN) 101. The MFPs 102, 103, and 104 can also perform a job in corporation with each other via the LAN 101. The job includes a function of printing in which a plurality of devices cooperates to perform processing, for example, remote copy or cascade copy.

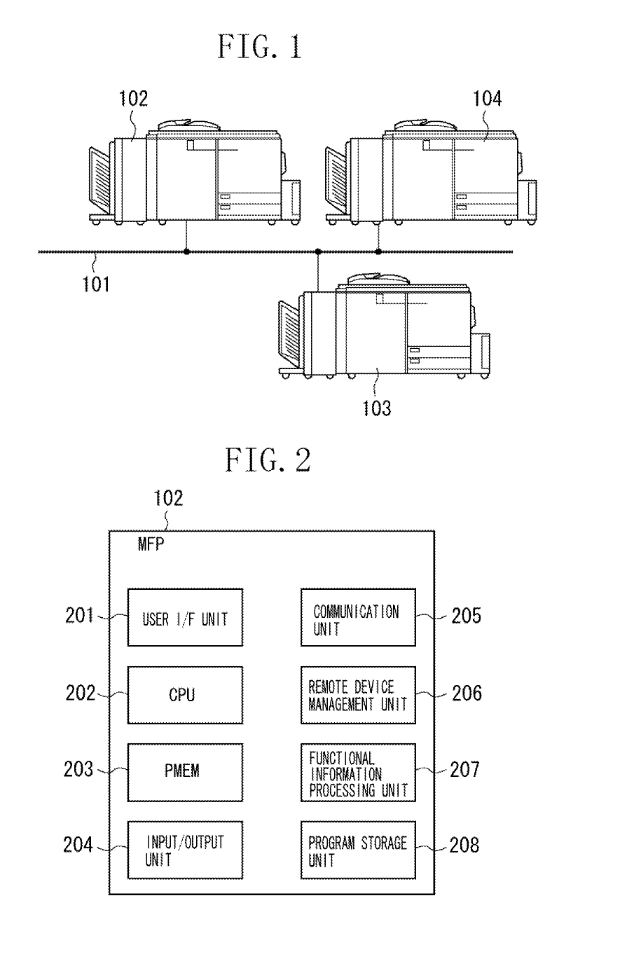

FIG. 2 is a block diagram illustrating a functional configuration of an MFP according to the exemplary embodiment of the present invention. While the MFP illustrated in FIG. 2 is MFP 102, it is noted that the MFPs 102, 103, and 104 have the functional configuration.

A user interface (I/F) unit 201 includes an operation unit and a display unit. An operation instruction is input into the user I/F unit 201 by a user of the operation unit, and information is displayed on the display unit for the user of the display unit. A central processing unit (CPU) 202 controls operation of the MFP 102 according to a program stored in a program memory (PMEM) 203 that is a random access memory (RAM). The program is selectively read out from a program storage unit 208 to be stored in the PMEM 203, and executed. Data that is input by the user via the user I/F unit 201 and image data that is read using an input/output unit 204 is stored in the PMEM 203. The input/output unit 204 includes a scanner that reads data of an original and a printer unit that prints an image according to print data. The input/output unit 204 reads data of an original and inputs the data as image data, and performs printing based on the read image data or image data input via the LAN 101. A communication unit 205 performs input/output control of data communicating via the LAN 101. In the exemplary embodiment, the LAN 101 is described as an example of the network.

However, the communication line connected to the communication unit 205 may be a public line, a dedicated line, or a network such as the Internet, etc. A remote device management unit 206 manages another MFP that cooperates with the MFP 102 through the LAN 101. A functional information processing unit 207 stores functional information that belongs to the MFP 102, and manages functional information of the cooperative MFP. The program storage unit 208 includes a hard disk and a read-only memory, and application programs for implementing various functions are installed in the program storage unit 208.

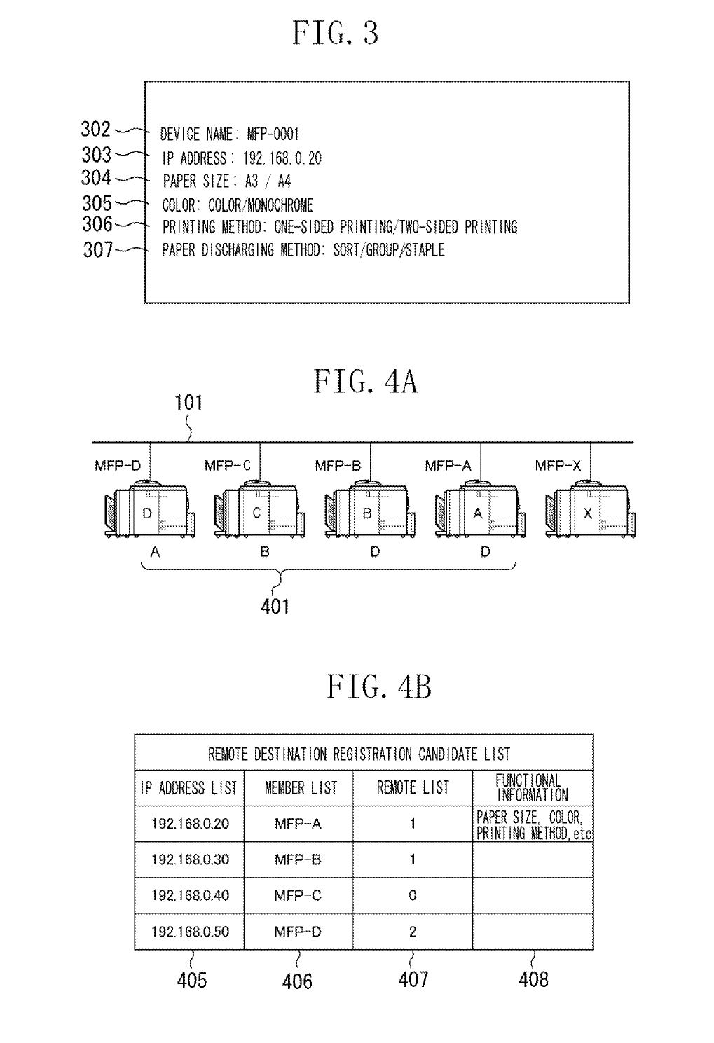

FIG. 3 is a view illustrating an example of functional information of a device managed by the functional information processing unit 207 according to the exemplary embodiment of the present invention.

In FIG. 3, reference numeral 302 denotes a name of the device, which includes functional information of the device (in FIG. 3, “MFP-0001”). An IP address 303 indicates an address for connecting the device to the LAN 101. A paper size 304 indicates a size of an original readable by the scanner unit of the input/output unit 204 of the device, and a paper size printable by the print unit. In the case of FIG. 3, the readable original size is “A3”, and the printable paper size is “A4”. A color 305 indicates a color of the original that can be input or output by the input/output unit 204. In this case, either color or monochrome can be selected. A printing method 306 indicates a printing function in the print unit of the input/output unit 204. In the case of FIG. 3, one of “one-sided printing” and “two-sided printing” can be selected. A paper discharge method 307 indicates a paper discharge method (post-processing) of printed paper. In this case, the possible paper discharge methods include sort, group, and staple. The above-described information is necessary in the remote copy and the cascade copy.

FIGS. 4A and 4B are views illustrating a remote destination registration candidate list managed by the remote device management unit 206 according to the exemplary embodiment of the present invention. FIG. 4A illustrates an example of the system configuration, and FIG. 4B illustrates an example of the remote destination registration candidate list.

The remote destination registration candidate list includes an IP address list 405, a member list 406, a remote list 407, and functional information 408. In FIG. 4A, a plurality of MFPs (MFP-A to MFP-D and MFP-X) is connected to the LAN 101. Reference numeral 401 denotes names (A to D) of the MFPs that are remote devices registered in the remote device management unit 206 of each MFP. In this case, a remote device registered in the MFP-A is a MFP-D (D), a remote device registered in the MFP-B is a MFP-D (D), a remote device registered in the MFP-C is a MFP-B (B), and a remote device registered in the MFP-D is a MFP-A (A).

If the MFP-X is newly connected to the LAN 101, the MFP-X acquires information about the connected devices from the MFPs on the network, and generates a remote destination registration candidate list as illustrated in FIG. 4B.

In FIG. 4B, according to the exemplary embodiment, the IP address list 405 is used to manage the cooperative MFPs based on their IP addresses. The member list 406 includes names of the MFPs that are connected to the LAN 101. The remote device list 407 includes the number of times an MFP listed in the member list 406 has been registered as a remote device in another MFP. In this case, as illustrated in FIG. 4A, the MFP-A and the MFP-B are registered as the remote devices in the MFP-D and the MFP-C respectively, and accordingly, the number of registrations is “1”. The MFP-C is not registered in any MFP as the remote device, and accordingly, the number of registrations is “0”. The MFP-D is registered in the MFP-A and the MFP-B as the remote device, and accordingly, the number of registrations is “2”. The functional information 408 includes functional information of each MFP listed in the member list 406.

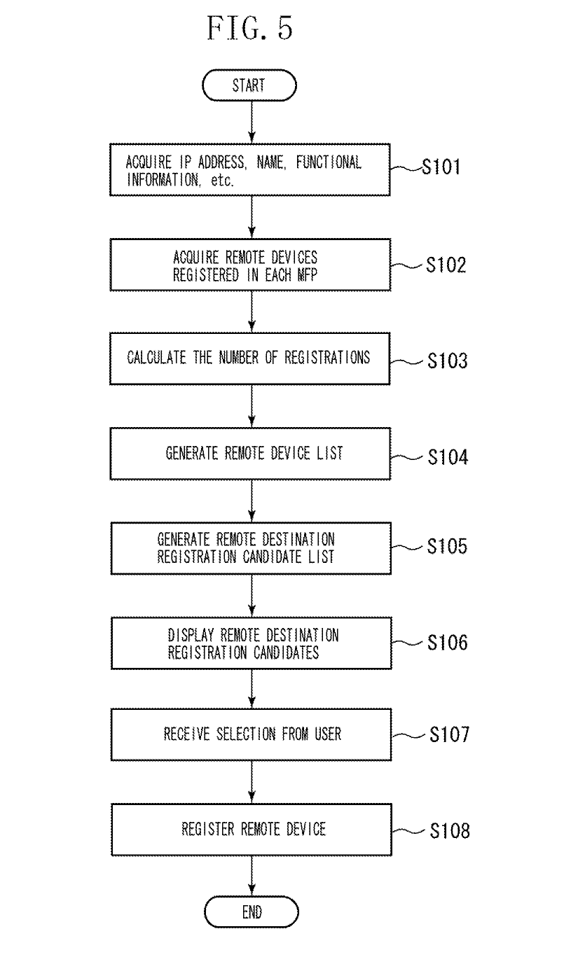

FIG. 5 is a flowchart illustrating an example of a flow of searching for a MFP that is to be registered as a remote device in the MFP-X in a case where the MFP-X is newly connected to the LAN 101 as described above. At the time of execution of the program implementing the processing, the program is loaded from the program storage unit 208 to the PMEM 203 and executed under control of the CPU 202.

The CPU 202 of the MFP-X, in step S101, acquires device information, that is, IP addresses, names of the MFPs, and functional information (paper sizes, colors, printing methods, and paper discharge methods) of MFPs connected to the LAN 101. Then, the CPU 202 generates the IP address list 405, the member list 406, and the functional information 408 in the remote destination registration list of the MFP-X. In step S102, based on the IP addresses acquired in step S101, the CPU 202 acquires the name of the remote devices registered in the remote device management unit 206 of each MFP from each MFP. In the case of FIGS. 4A and 4B, the MFP-X acquires the MFP-D from the MFP-A. From the MFP-B, the MFP-X acquires the MFP-D. From the MFP-C, the MFP-X acquires the MFP-B. From the MFP-D, the MFP-X acquires the MFP-A. In step S103, the CPU 202 calculates the number of the names based on the names of the remote devices acquired in step S102. In the case of FIGS. 4A and 4B, the MFP-A is “1”, the MFP-B is “1”, the MFP-C is “0”, and the MFP-D is “2”. In step S104, based on the number calculated in step S103, the CPU 202 generates the remote list 407 in the remote destination registration candidate list. In step S105, based on the IP address list 405, the member list 406, and the functional information 408 generated in step S101, as well as the remote list 407 generated in step S104, the CPU 202 generates a remote destination registration candidate list illustrated in FIG. 4B. In step S106, based on the remote list 407 in the remote destination registration candidate list, the CPU 202 performs display control for displaying the candidate MFPs to be registered in the MFP-X as the remote device on the display unit provided in the user I/F unit 201. The contents to be displayed may include not only the names and IP addresses of candidate MFPs, but also the functional information and the number of registrations of the device registered in the other MFPs as the remote device. Moreover, the CPU 202 may display only an MFP that has the smallest registration number registered by the other MFPs as the remote device. In such a case, as to FIGS. 4A and 4B, only the MFP-C is displayed. In step S107, the user selects via the user I/F unit 201 the MFP that is to be registered as the remote device in the MFP-X from among the candidates displayed in step S106. The CPU 202 receives a selection of the MFP that is to be registered as the remote device. The user can select a plurality of MFPs. In step S108, the CPU 202 registers the MFP received in step S107 in the remote management part 206 as the remote device, and the processing ends.

In the display processing in step S106, the MFPs may be displayed in the priority order from an MFP that has a smallest registration number registered as remote device.

Moreover, in step S106, it is possible not to register an MFP that has a registration number as a remote device which is greater than or equal to a predetermined value (threshold value).

Further, in step S107, if the registration number selected and registered as remote device of the MFP by the user is greater than or equal to a predetermined value (threshold value), a warning may be displayed for the user.

Further, in the case of FIG. 5, the remote device that is to be registered in the MFP is selected by the user. However, the selection may also be automatically performed by the MFP. In such a case, the MFP to be registered as remote device may be automatically extracted and registered by extracting a MFP that has a registration number equal to a predetermined value or less, registered as remote device in other MFPs.

The present invention can be applied to a system including a plurality of devices or an apparatus consisting of a single device.

In the above description of the exemplary embodiment, as an example of the image forming apparatus, an MFP is used. However, the image forming apparatus registered as a remote device may also be a printer that does not have a scanner function, a facsimile device, or a copying machine. That is, the remote copy and the cascade copy may be performed not only in the cooperation of MFPs, but also in cooperation between an MFP and a printer or between a copying machine and a printer, etc.

Further, a software program implementing the functions of the above-described exemplary embodiment may be directly or remotely provided to a system or an apparatus. Then, a computer in the system or the apparatus achieves an aspect of the present invention by reading and executing the provided program code.

Accordingly, the program code itself installed in the computer to implement the functional processing of an aspect of the present invention, implements the functions of the present invention. That is, the computer program itself for implementing the functional processing of the present invention constitutes the present invention. In such a case, if the function of the program is included, any type of the program code may be employed as the program, for example, a program implemented with an object code or an interpreter, and script data to be supplied to an operation system (OS) may be employed.

As the recording medium for supplying such program code, for example, a floppy disk, a hard disk, and an optical disk may be employed. Further, a magneto-optical disk (MO), a compact disk read-only memory (CD-ROM), a CD-recordable (CD-R), a CD-rewritable (CD-RW), a magnetic tape, a nonvolatile memory card, a ROM, and a DVD (a DVD-read only memory (DVD-ROM) and a DVD-R) may be employed.

In addition, the program may be supplied by connecting to a home page (web page) of the Internet using a browser of a client computer. Then, the program is supplied from the home page by downloading the computer program itself of the present invention onto a recording medium such as a hard disk, etc. In such a case, the computer program itself of the present invention or a compressed file including an automatic installation function may be downloaded. Further, the program code constituting the program according to the present invention may be divided into a plurality of files, and each file may be downloaded from different home pages. That is, a world wide web (WWW) server which allows a plurality of users to download the program file for realizing the function processing of the present invention with the computer is also included in the present invention.

Further, the program according to the present invention may be encrypted and stored in a storage medium such as a CD-ROM, and distributed to the users. In such a case, users who have cleared prescribed conditions are allowed to download key information for decrypting the cipher from a home page through the Internet. The users execute the encrypted program using the key information, and the program is installed on the computers.

Further, other types than the above-described type that a computer implements the read program to realize the functions of the exemplary embodiments may be employed. For example, based on an instruction according to the program code, an OS and the like running on the computer executes a part or the whole of the actual processing, and thus, the function of the above-described embodiments may be realized.

Moreover, the program code read from the storage medium is written onto a memory which is provided in a function enhancing board inserted in the computer or in a function enhancing unit connected to the computer. Then, based on an instruction according to the program code, a central processing unit (CPU) or the like provided in the function enhancing board or in the function enhancing unit executes a part or the whole of the actual processing, and thus, the function of the above described embodiments may be realized.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-039826 filed on Feb. 20, 2007, which is hereby incorporated by reference herein in its entirety.

What is claimed:

1. An image forming apparatus comprising:
a device information acquisition unit configured to acquire information about at least one remote device registered as a target device with which the at least one device cooperates, from at least one device;
a display control unit configured to display at least one candidate remote device to be registered as a target device with which the image forming apparatus cooperates based on the information acquired by the device information acquisition unit;
a selection unit configured to select the at least one candidate device to be registered as a target device with which the image forming apparatus cooperates; and
a registration unit configured to register any selected at least one candidate remote device.

2. The image forming apparatus according to claim 1, further comprising a calculation unit configured to calculate a number of remote devices registered in the device based on the information acquired by the device information acquisition unit,
wherein the display control unit displays candidate remote devices where the number of remote devices registered in a candidate remote device is less than a predetermined threshold value.

3. The image forming apparatus according to claim 2, wherein candidate remote devices are displayed in order from a candidate remote device with a smallest number of registered remote devices.

4. A method for controlling an image forming apparatus capable of performing cooperative processing with at least one device, the method comprising:
acquiring information about at least one remote device registered as a target device with which the at least one device cooperates with from at least one device;
displaying at least one candidate remote device to be registered as a target device with which the image forming apparatus cooperates based on the acquired information about the at least one remote device;
selecting the at least one candidate device to be registered as a target device with which the image forming apparatus cooperates; and
registering any selected at least one candidate remote device.

5. The method according to claim 4, further comprising calculating a number of remote devices registered in the device based on the information about the at least one remote device, wherein candidate remote devices are displayed where the number of remote devices registered in a candidate remote device is less than a predetermined threshold value.

6. The method according to claim 5, wherein candidate remote devices are displayed in order from a candidate remote device with a smallest number of registered remote devices.
